(19) United States
(12) Patent Application Publication
(10) Pub. No.: US 2012/0043749 A1
(43) Pub. Date: Feb. 23, 2012

(54) BUSINESS FORM WITH LABEL

(76) Inventor: Watson Gullett, Spring Valley, OH (US)

(21) Appl. No.: 12/860,964

(22) Filed: Aug. 23, 2010

(51) Int. Cl. B42D 15/00; B32B 3/10

(52) U.S. Cl. 283/81; 428/195.1

(57) ABSTRACT

A business form has a carrier sheet and a label assembly. The carrier sheet has an upper surface and a lower surface, and defines a die cut opening through the carrier sheet. The carrier sheet has release material surrounding the die cut opening on the lower surface of the carrier sheet. The business form has a label assembly mounted on the lower surface of the carrier sheet, and extending over said opening. The label assembly has an upper surface facing the die cut opening. The label assembly is free of any paper material, and the label assembly includes a layer of pressure sensitive adhesive around its periphery on its upper surface. The layer of pressure sensitive adhesive engages the release material when the label assembly is on the carrier sheet and engages the interior surface of an automobile window. The label assembly is printed through the die cut opening before being removed from said carrier sheet.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

This relates to a business form and, more particularly, to a form of the type that carries a label, with the label and the balance of the business form both being printed with variable indicia. Business forms of this type have gained wide use for numerous applications. For example, it is common to provide an automobile registration label on a letter size business form, and to print both the registration label and the balance of the form at the license bureau when the owner presents a renewal application. Then the label can be removed from the form by the owner and applied to the license plate or to some other part of the vehicle, such as for example the windshield. The remainder of the business form is retained by the owner as a vehicle registration document.

Various form constructions of this general type are in common use. In one such construction, the label is mounted in a cutout window defined by the principal carrier ply of the business form. The label may be held in place in the window by a patch of release material attached to the back of the carrier ply and extending across the cutout window. This construction has the advantage that the top surface of the label is somewhat lower than would be the case if the label were simply mounted on top surface of the carrier ply. As a consequence, the movement of such a form through a printer is facilitated since the upper surface of the carrier ply and the upper surface of the label are at approximately the same level. With a construction of this type, it is less likely that a label will become accidentally separated from the form and cause a printer jam, or otherwise impact printing operations.

### SUMMARY

A business form comprises a carrier sheet having an upper surface and a lower surface, and defining a die cut opening there through. The carrier sheet has a layer of release material surrounding the die cut opening on the lower surface of the carrier sheet. A label assembly is mounted on the lower surface of the carrier sheet. The label assembly extends across the opening, and has an upper surface facing the die cut opening. The label assembly is free of any paper material. The label assembly includes a layer of pressure sensitive adhesive around its periphery on its upper surface for engaging the layer of release material when the label assembly is on the carrier sheet. The pressure sensitive adhesive engages the interior surface of an automobile windshield after the label assembly is printed through the die cut opening and removed from the carrier sheet, and applied to the windshield glass surface.

The business form has a label assembly that includes a first, upper ply of a retro-reflective material, and a second, lower ply of a polyester material. The label assembly includes a layer of pressure sensitive adhesive between the first and second plies of the label assembly. The layer of pressure sensitive adhesive around the periphery on the upper surface of the label assembly is an adhesive which destructively releases from a glass surface. As a consequence, once the label assembly has been mounted on the interior surface of an automobile window and removed from the window, the destruction of the adhesive layer makes it apparent that such mounting and removal has occurred. Accordingly, the theft of such labels is deterred. The layer of pressure sensitive adhesive may be a stretch and release adhesive, which adhers in part to the glass surface when the label is removed from the glass in a very apparent manner.

The release material surrounding the die cut opening on the lower surface of the carrier sheet may comprise a barrier coating surrounding the die cut opening on the lower surface of the carrier sheet, and a coating of silicone material over the barrier coating, surrounding the die cut opening on the lower surface of the barrier sheet. The label assembly may include a first, upper ply of a white colored material, and a second, lower ply of a polyester material. The first, upper ply of a white colored material may comprise a retro-reflective tape layer. The carrier sheet may include a sheet of bond paper material.

### BRIEF DESCRIPTION OF THE DRAWINGS

FIG. 1 is a plan view of the business form of the type which includes a label assembly;

FIG. 2 is a sectional view, taken generally along line 2-2 in FIG. 1, of the business form, with the thicknesses of the various material plies, coatings and layers exaggerated for purposes of clarity;

FIG. 3 is a sectional view, similar to FIG. 2, of another embodiment of the business form, with the thickness of the various plies, coatings and layers exaggerated for purposes of clarity.

### DETAILED DESCRIPTION

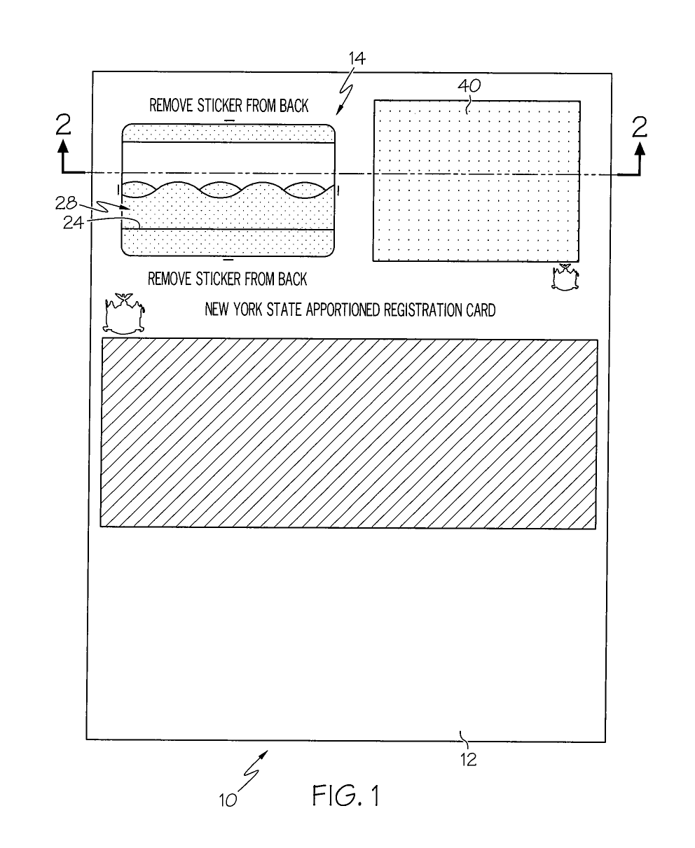

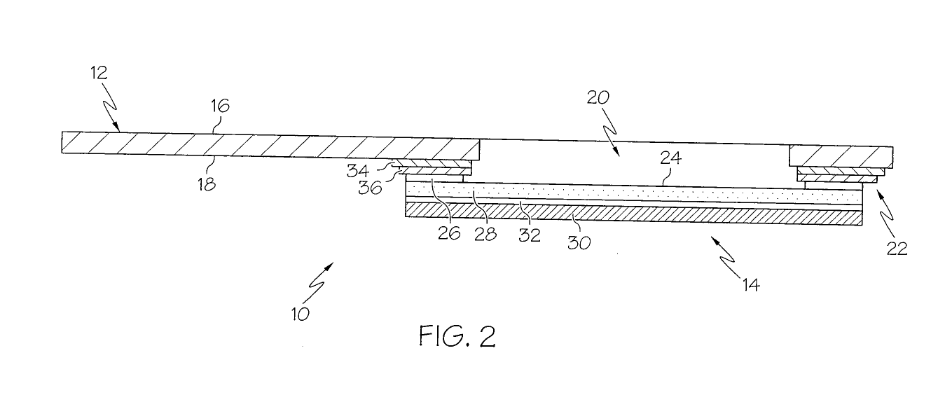

Reference is made to FIGS. 1 and 2 which illustrate the business form 10 to which this is directed. The business form 10 includes a carrier sheet 12 and a label assembly 14. The carrier sheet 12 has an upper surface 16 and a lower surface 18, and defines a die cut opening 20 through the carrier sheet. The carrier sheet 12 includes release material 22 surrounding the die cut opening 20 on the lower surface 18 of the carrier sheet 12. The label assembly 14 is mounted on the lower surface 18 of the carrier sheet 12, and extends over the opening. The label assembly 14 has an upper surface 24 facing the die cut opening 20. The label assembly 14 is free of any paper material. The label assembly 14 includes a layer of pressure sensitive adhesive 26 around its periphery on the upper surface 24 for engaging the release material 22 when the label assembly 14 is mounted on the carrier sheet 12. As will be explained more fully below, the pressure sensitive adhesive 26 is used in the illustrated construction to engage the interior surface of an automobile window after the label assembly 14 is printed and removed from the carrier sheet 12.

The label assembly 14 includes a first, upper ply 28 made of a reflective material such as a retro-reflective material, and a second, lower ply 30 made of a polyester material. Upper ply 28 made of 3M 5490 white reflective material, a material which is retro reflective. The second ply 30 may be made of polyester material, and plies 28 and 30 are held together by a layer of pressure sensitive adhesive 32 extending between the first and second plies 28 and 30 of the label assembly 14. The layer of pressure sensitive adhesive 26 around the periphery on the upper surface 24 of the label assembly 14 may be an adhesive of the type which destructively releases from a glass surface. With this type of adhesive, once the label assembly has been mounted on the interior surface of an automobile window and removed from the window, for example, the destruction of the adhesive layer makes it apparent that the label assembly 14 has been used. The adhesive does not retain its adhesion capabilities, and reuse of the label assembly is prevented. An example of a suitable destructive release adhesive is 5290 Adhesive, available from 3M.

The release material 22 on the lower surface 18 of the carrier sheet 12 comprises a barrier coating 34 that surrounds the die cut opening 20, and a coating 36 of silicone material that extends over the barrier coating 34. The carrier sheet 12 may be a sheet of bond paper material or a sheet of coated paper stock. Alternatively, the carrier sheet 12 may be made up of any other sheet material, coated or uncoated. The layer of pressure sensitive adhesive 26 around the periphery of the upper surface of the label assembly 14 may be a stretch and release adhesive which destructively releases from a glass surface as the label assembly is peeled from the glass surface. When the label assembly is mounted on and removed from the interior surface of an automobile window, the destruction of the adhesive layer makes it apparent that such mounting and removal has occurred. The lower ply 30 may be made of synthetic, a material other than polyester, with the synthetic material being selected to tolerate temperatures typical of laser or thermal transfer printers.

The business form of FIGS. 1 and 2 will find wide usage, such as for example in a vehicle license bureau environment. A supply of such forms is maintained in a laser printer at the license bureau office. When a vehicle owner applies for a renewal registration and a new registration label for display on the vehicle, the printer is activated through appropriate software to print the registration information on a selected portion 40 of the upper surface 16 of carrier sheet 12. The printer also prints the necessary information on the upper surface 24 of the label assembly 14. After receiving the printed business form, the vehicle owner removes the label assembly 14 from the business form and applies it to the vehicle.

The adhesive 26 permits the label assembly 14 to be peeled from the lower surface 18 of the form, and then secured to the inside of the vehicle windshield. The label assembly is thereafter securely held in place on the glass surface by the adhesive and withstands the heat and humidity commonly encountered in a vehicle interior, especially during the summer months. As explained above, when the label assembly 14 is removed from a glass surface on which it is mounted, the adhesive 26 is destroyed in a way that is clearly evident, even under casual inspection. For example, part of the adhesive may be carried by the label assembly, while a part of the adhesive remains on the glass. The adhesive that remains on the periphery of the label assembly is no longer capable of securely mounting the label assembly 14 on a glass surface, with the result that the theft of such vehicle registration labels is deterred.

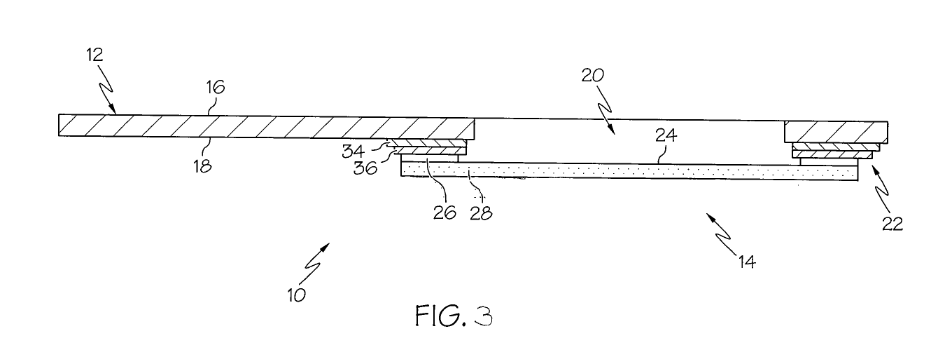

FIG. 3 is a sectional view of another embodiment in which the lower ply 30 and the adhesive layer 32 have been eliminated from the label assembly 14. The various elements are labeled with the reference numerals that correspond to the same elements found in the embodiment of FIG. 2. The embodiment of FIG. 3 may be utilized when the reflective ply 28 is sufficiently dimensionally stable that there is no significant shape distortion when the label assembly is subjected to printing temperatures.

The business form of FIGS. 1-3 have a number of valuable attributes. It will be appreciated that the business form 10 can be variably imaged, with the label assembly and the carrier sheet being printed during a single pass of the business form through the printer. Further, it will be appreciated that because no paper components are used in the label assembly, the label assembly is capable of withstanding the difficult environmental conditions that are frequently encountered inside the passenger compartment of an automobile. This results in a label that remains securely in place on the windshield interior surface throughout the anticipated useful life of the label. It will be appreciated that business forms of the type disclosed herein may be printed with thermal transfer printers, with the form being made of a thermal transfer coated paper.

What is claimed is:

1. A business form, including a label assembly, comprising:
a carrier sheet having an upper surface and a lower surface, and defining a die cut opening there through, said carrier sheet including release material surrounding said die cut opening on said lower surface of said carrier sheet, and
a label assembly mounted on said lower surface of said carrier sheet, and extending over said opening, said label assembly having an upper surface facing said die cut opening, said label assembly being free of any paper material, and said label assembly including a layer of pressure sensitive adhesive around its periphery on said upper surface for engaging said release material when said label assembly is on said carrier sheet and for engaging the interior surface of an automobile window when said label assembly is printed through said die cut opening and removed from said carrier sheet.

2. The business form of claim 1, in which said label assembly includes a first, upper ply of a retro-reflective material, and a second, lower ply of a polyester material.

3. The business form of claim 2, in which said label assembly further includes a layer of pressure sensitive adhesive between said first and second plies of said label assembly.

4. The business form of claim 1, in which said layer of pressure sensitive adhesive around the periphery on the upper surface of said label assembly is an adhesive which destructively releases from a glass surface such that once the label assembly has been mounted on the interior surface of an automobile window and removed from the window, the destruction of the adhesive layer makes it apparent that such mounting and removal has occurred.

5. The business form of claim 1, in which said release material surrounding said die cut opening on said lower surface of said carrier sheet comprises a barrier coating surrounding said die cut opening on said lower surface of said carrier sheet, and a coating of silicone material over said barrier coating, surrounding said die cut opening on said lower surface of said barrier sheet.

6. The business form of claim 1, in which said label assembly includes a first, upper ply of a white colored material, and a second, lower ply of a polyester material.

7. The business form of claim 6, in which said first, upper ply of a white colored material comprises a retro-reflective tape layer.

8. The business form of claim 1, in which said carrier sheet includes a sheet of bond paper material.

9. The business form of claim 1, in which said layer of pressure sensitive adhesive around the periphery on the upper surface of said label assembly is a stretch and release adhesive which destructively releases from a glass surface such that once the label assembly has been mounted on the interior surface of an automobile window and removed from the window, the destruction of the adhesive layer makes it apparent that such mounting and removal has occurred.

10. A label assembly, comprising:
a first, upper ply of a reflective material having an upper surface,
a layer of pressure sensitive adhesive on said upper surface around the periphery thereof for engaging the interior surface of an automobile window,
a second, lower ply of a polyester material, and
a layer of pressure sensitive adhesive between said first and second plies, said label assembly being free of any paper material.

11. The label assembly of claim 10, in which said layer of pressure sensitive adhesive around the periphery on the upper surface of said label assembly is an adhesive which destructively releases from a glass surface such that once the label assembly has been mounted on the interior surface of an automobile window and removed from the window, the destruction of the adhesive layer makes it apparent that such mounting and removal has occurred.

12. The label assembly of claim 10, in which said first, upper ply comprises a ply of a white colored material.

13. The label assembly of claim 12, in which said ply of white colored material comprises a ply of retro-reflective tape.

14. The label assembly of claim 10, in which said layer of pressure sensitive adhesive around the periphery on the upper surface of said label assembly is a stretch and release adhesive which destructively releases from a glass surface such that once the label assembly has been mounted on the interior surface of an automobile window and removed from the window, the destruction of the adhesive layer makes it apparent that such mounting and removal has occurred.

15. A business form, including a label assembly, comprising:
a carrier sheet having an upper surface and a lower surface, and defining a die cut opening there through, said carrier sheet including release material surrounding said die cut opening on said lower surface of said carrier sheet, and
a label assembly mounted on said lower surface of said carrier sheet, and extending over said opening, said label assembly being free of any paper material, and said label assembly comprising
a ply of reflective material having an upper surface facing said die cut opening, and
a layer of pressure sensitive adhesive around the periphery of said ply of reflective material on said upper surface for engaging said release material when said label assembly is on said carrier sheet and for engaging the interior surface of an automobile window after said label assembly is printed through said die cut opening and removed from said carrier sheet.

16. The business form of claim 15, in which said layer of pressure sensitive adhesive around the periphery on the upper surface of said label assembly is an adhesive which destructively releases from a glass surface such that once the label assembly has been mounted on the interior surface of an automobile window and removed from the window, the destruction of the adhesive layer makes it apparent that such mounting and removal has occurred.

17. The business form of claim 15, in which said release material surrounding said die cut opening on said lower surface of said carrier sheet comprises a barrier coating surrounding said die cut opening on said lower surface of said carrier sheet, and a coating of silicone material over said barrier coating, surrounding said die cut opening on said lower surface of said barrier sheet.

18. The business form of claim 15, in which said ply of reflective material comprises a ply of retro-reflective material.

19. The business form of claim 18, in which said ply of retro-reflective material comprises a retro-reflective tape layer.

20. The business form of claim 15, in which said carrier sheet includes a sheet of bond paper material.

21. The business form of claim 15, in which said layer of pressure sensitive adhesive around the periphery on the upper surface of said label assembly is a stretch and release adhesive which destructively releases from a glass surface such that once the label assembly has been mounted on the interior surface of an automobile window and removed from the window, the destruction of the adhesive layer makes it apparent that such mounting and removal has occurred.
